(19) United States
(12) Patent Application Publication
(10) Pub. No.: US 2014/0034467 A1
(43) Pub. Date: Feb. 6, 2014

(54) ILLUMINATED KEYBOARD WITH A LIGHT TRANSMISSION CHANNEL

(71) Applicant: Chin-Wen CHOU, New Taipei City (TW)

(72) Inventor: Chin-Wen CHOU, New Taipei City (TW)

(21) Appl. No.: 13/564,174

(22) Filed: Aug. 1, 2012

(51) Int. Cl. H01H 13/83

(52) U.S. Cl. 200/5 A

(57) ABSTRACT

An illuminated keyboard with a light transmission channel contains a substrate used to hold a plurality of press units, a circuit board disposed on the substrate and triggered by the press units, and a light shielding unit disposed on the circuit board and having a permeable area and a light impermeable area. The light impermeable area of the light shielding unit and a non-transparent surface of the circuit board form a light transmission channel between the substrate and the plurality of press units. The illuminated keyboard also contains at least one illuminating unit to emit light into the light transmission channel, thus the light can be projected to the plurality of press units through the light permeable area of the light shielding unit.

### FIELD OF THE INVENTION

The present invention relates to an illuminated keyboard, and more particularly to an illuminated keyboard with a light transmission channel formed between a substrate and a plurality of press units.

### BACKGROUND OF THE INVENTION

A keyboard device is applied to a computer system to output commands and its design focuses on whether a user can input command signals comfortably and exactly. Under a condition with insufficient light, the user, who is unfamiliar with the arrangement of characters and symbols on the keycaps, cannot input the commands quickly. To facilitate users to clearly identify the characters and symbols on the keycaps under the dim light environment, a variety of illuminated keyboards have been developed by manufacturers.

Conventional illuminated keyboards such as U.S. Pat. Nos. 5,936,554 and 7,278,750 and TW Patent Nos. 566612 and 581961 disclose a keyboard with a light emitting diode disposed in every key thereof to function as a light source. However, the standard keyboards nowadays have more than one hundred keys, if the light emitting diode is fixed in every key, a number of key components must be increased, thus not only increasing manufacture processes and production cost, but also increasing product weight.

To solve the above-mentioned disadvantages, improved illuminated keyboards with luminous elements by means of a light guide plate have been disclosed in U.S. Pat. Nos. 6,648,530, 6,860,612, 7,531,764 and TW Patent Nos. 516671, 587800, and 594546. These illuminated keyboards use a luminous panel, such as an electroluminescent sheet or an optical fiber panel, to replace a great number of light emitting diodes. Such illuminated keyboards emit light evenly by means of this single luminous panel, thereby decreasing needed components to simplify manufacture processes and lower production cost.

Although a uniform illumination effect can be achieved by using the light guide plate, the brightness is not sufficient because of scattered lights. The user therefore cannot clearly identify the character or symbol on each keycap.

To overcome the above-mentioned imperfection, an unevenly illuminated keyboard is proposed in U.S. Pat. No. 7,154,059 that includes a shielding element fixed between a plurality of keycaps and a light guide plate, wherein the shielding element has a light permeable area located at each keycap and a light impermeable area adjacent to the keycaps. The shielding element merely allows the light to penetrate the light permeable area, thus generating brightness only to the keycaps.

Besides the above-mentioned light guide plate, a light guide bar is also used in prior art to serve as the luminous element. For example, an illuminated keyboard disclosed in TW Publication No. 201115609 contains a keyboard portion and at least one light guide bar. The keyboard portion includes a plurality of press unit assemblies parallel to each other and a substrate to hold the plurality of press unit assemblies. The at least one light guide bar is disposed between any two neighboring press unit assemblies and at least includes a light impermeable area and a light permeable area. The at least one light guide bar directly projects light to the keycaps at a predetermined angle of the light permeable area. Compared with the illuminated keyboards using the light guide plate to function as the luminous element, such an approach fully utilizes the fixed space in the keyboard to achieve illumination effect, not only the keyboard can be fabricated at a thinner thickness, but also the weight thereof is lighter.

To further decrease the weight and thickness of the illuminated keyboard, an illuminated keyboard without a light guiding portion is developed in TW Patent No. 1320901 that uses a circuit board to provide light. This illuminated keyboard includes a plurality of keycaps, a back plate to hold the keycaps, and an illuminated circuit board to integrate a key circuit and a luminous member. This illuminated circuit board can provide enough light for the keycaps, thereby decreasing the weight and thickness of the illuminated keyboard. Another illuminated keyboard disclosed in TW Patent No. 1350465 includes a casing comprised of an upper lid and a bottom lid, a keyboard portion secured in the casing, and at least one illumination unit. The bottom lid has a first light guiding area formed thereon. The at least one illumination unit supplies light to the first light guiding area of the casing so that the light diffuses in the first light guiding area and projects upward to the keyboard portion. In such embodiment, light is directly transmitted in the light guiding area to illuminate the keyboard portion without passing through light guiding portion, thus decreasing the weight and thickness of the illuminated keyboard.

In addition to the above-mentioned approach, a light collecting post also can be utilized to improve the disadvantage of unclear identification of characters on the keycaps due to uniform illumination. The light collecting post is mounted in the first light guiding area corresponding to the keyboard portion to condense the light to supply for the keyboard portion.

From the aforesaid descriptions, it is obvious that the current trend of the illuminated keyboard is towards slimness and uneven illumination. In order to achieve slimness, it is preferable that a light guiding space is used to replace the light guiding portion which occupies a physical space. To obtain uneven illumination, it is important to divide the light impermeable area and the light permeable area in the keyboard. A slim illuminated keyboard with uneven illumination function is thus developed by manufacturers.

The illuminated keyboards mentioned above further can be divided into two types according to the position of the light source.

In the first type, a light source is located under the keyboard portion to project light upward, such as an illuminated keyboard disclosed in TW Patent No. 509955. This illuminated keyboard includes a keyboard portion and a backlight device disposed under the keyboard portion. The backlight device supplies light to the keyboard portion from of the underneath of the keyboard portion.

In the second type, a light source is located in the keyboard portion to project light laterally, such as an illuminated keyboard disclosed in U.S. Pa. No. 8,144,035. This illuminated keyboard includes a keyboard portion and a luminous portion. The keyboard portion has a pressing plane and a substrate underneath the pressing plane, wherein the luminous portion emits light to form a light emitting area between the pressing plane and the substrate, thus generating brightness in the light emitting area.

Even though the brightness of the illuminated keyboard in the second type is higher than that in the first type because of different light transmission distances, the illuminated keyboard in the second type still has imperfections. For instance, as a thin-film circuit board in the keyboard is made of plastic material, a part of the light in the keyboard portion might penetrate the thin-film circuit board and diffuse in the keyboard portion.

### SUMMARY OF THE INVENTION

The primary object of the present invention is to provide an illuminated keyboard without providing any light guiding portion to achieve slimness and uneven illumination effect.

Another object of the present invention is to solve the imperfection of conventional illuminated keyboards that the light inside the keyboard portion penetrates the thin-film circuit board to result in loss of a part of the light in the keyboard portion.

To achieve the above-mentioned objects, the present invention proposes an illuminated keyboard with a light transmission channel that contains a plurality of press units and a substrate to hold the plurality of press units. Each of the press units and the substrate is bridged by a movement member to allow the press unit to move towards the substrate. The illuminated keyboard further contains a circuit board disposed on the substrate to generate command signals when the plurality of press units move towards the substrate, a light shielding unit which is disposed on the circuit board and includes a light permeable area and a light impermeable area, and at least one illuminating unit disposed between the circuit board and the light shielding unit. A non-transparent surface of the circuit board and the light impermeable area of the light shielding unit form a light transmission channel between the substrate and the plurality of press units so that light generated by the at least one illuminating unit is transmitted in the light transmission channel, and then projected into the plurality of press units via the light permeable area of the light shielding unit.

In one embodiment, the circuit board includes an upper film, a lower film, and an intermediate film disposed between the upper film and the lower film.

In one embodiment, the non-transparent surface is a reflective layer or an opaque layer located on the lower film.

In one embodiment, the non-transparent surface is a reflective layer or an opaque layer located on the intermediate film.

In one embodiment, the non-transparent surface is a reflective layer or an opaque layer located on the upper film.

In one embodiment, the lower film is made of an opaque material or a reflective material.

In one embodiment, the intermediate film is made of an opaque material or a reflective material.

In one embodiment, the upper film is made of an opaque material or a reflective material.

In one embodiment, the upper film includes an upper key circuit, the lower film includes a lower key circuit, and the intermediate film includes a plurality of through-holes to allow the upper key circuit and the lower key circuit to form conduction.

In one embodiment, the plurality of press units arranged in each row are defined as a press unit assembly, and the at least one illuminating unit is located in the light transmission channel between any two neighboring press unit assemblies.

In one embodiment, the least one illuminating unit includes a light guide bar and a plurality of luminous elements embedded in the light guide bar.

In one embodiment, each luminous element is a light emitting diode.

In one embodiment, the movement member includes a linkage mechanism connecting the substrate with each of the press units and a resilient element disposed in the linkage mechanism. In one embodiment, the light permeable area includes a plurality of apertures to allow multiple resilient elements to trigger the circuit board when moving towards the substrate.

In one embodiment, the linkage mechanism is made of a transparent material.

In one embodiment, the resilient element is made of a transparent material.

In one embodiment, the substrate includes at least one positioning portion to secure the linkage mechanism thereon.

In one embodiment, the light permeable area corresponds to the plurality of press units, and the light impermeable area corresponds to an area adjacent to the plurality of press units.

In one embodiment, the at least one illuminating unit is a light emitting diode.

Thereby, the illuminated keyboard of the present invention has the following advantages:

1. The light does not disperse from the illuminated keyboard as penetrating the circuit board. The present invention forms a light transmission channel between the substrate and the plurality of press units by a light impermeable area of the light shielding unit and a non-transparent surface of the circuit board. The light transmission channel conducts the light emitted by the at least one illuminating unit towards the only exit in the keyboard portion, namely the light permeable area of the light shielding unit. Hence the plurality of press units corresponding to the light permeable area receive almost all the light emitted from the at least one illuminating unit.

2. The illuminated keyboard can achieve slim and uneven illumination effect. The present invention does not need any light guiding portion, such as a light guide plate or a light guide bar, but utilizes a light transmission channel to obtain high brightness, wherein the smaller the cross section of the light transmission channel, the more condensed of the light, thus satisfying a light-weight and thin-thickness requirement. On the other hand, because the light permeable area of the light shielding unit corresponds to the plurality of press units, and the light impermeable area corresponds to an area adjacent to the plurality of press units, the illuminated keyboard of the present invention emits the light unevenly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the structure of a first embodiment of the present invention.

FIG. 2 is another exploded view of the structure of the first embodiment of the present invention.

FIG. 3 is a sectional view of the structure of the first embodiment of the present invention.

FIG. 4 is an exploded view of the structure of a second embodiment of the present invention.

FIG. 5 is a schematic view showing the transmission of light in the first embodiment of the present invention.

FIG. 6 is another schematic view showing the transmission of light in the first embodiment of the present invention.

FIG. 7 is yet another schematic view showing the transmission of light in the first embodiment of the present invention.

### DETAILED DESCRIPTION OF THE PREFERRED EMBODIMENTS

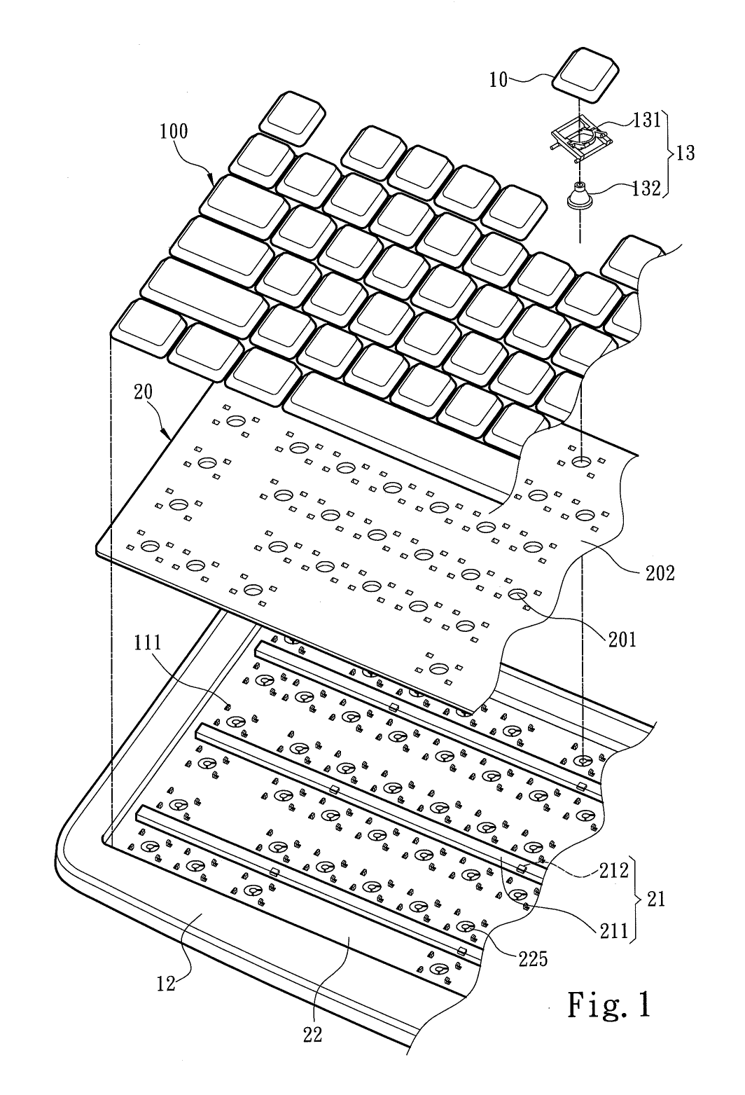

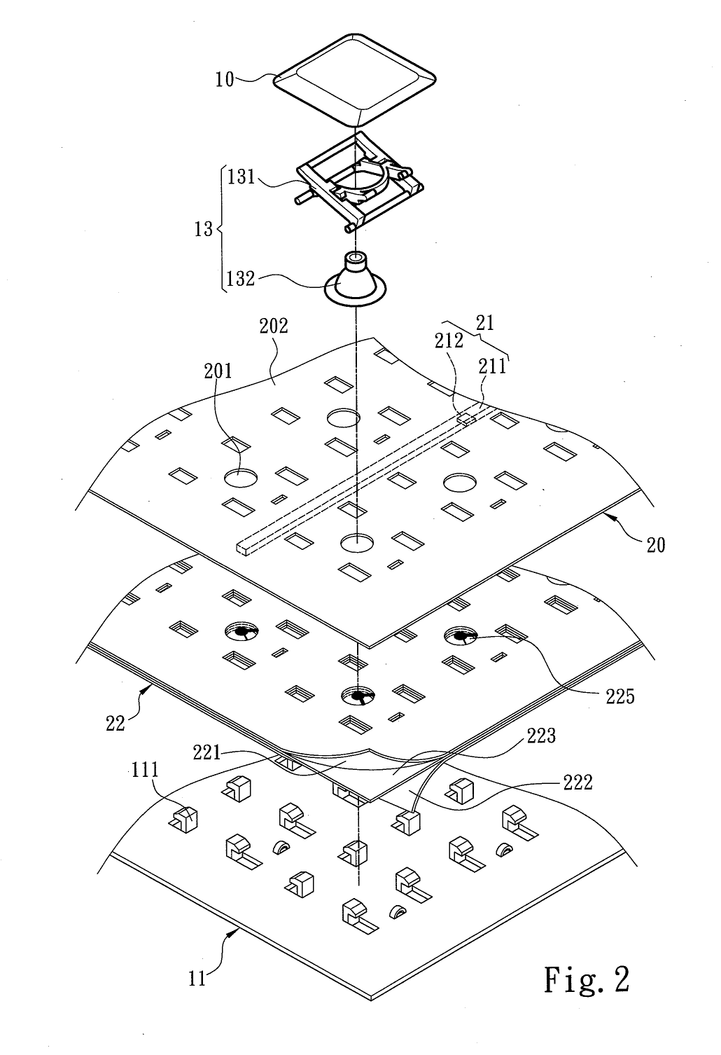

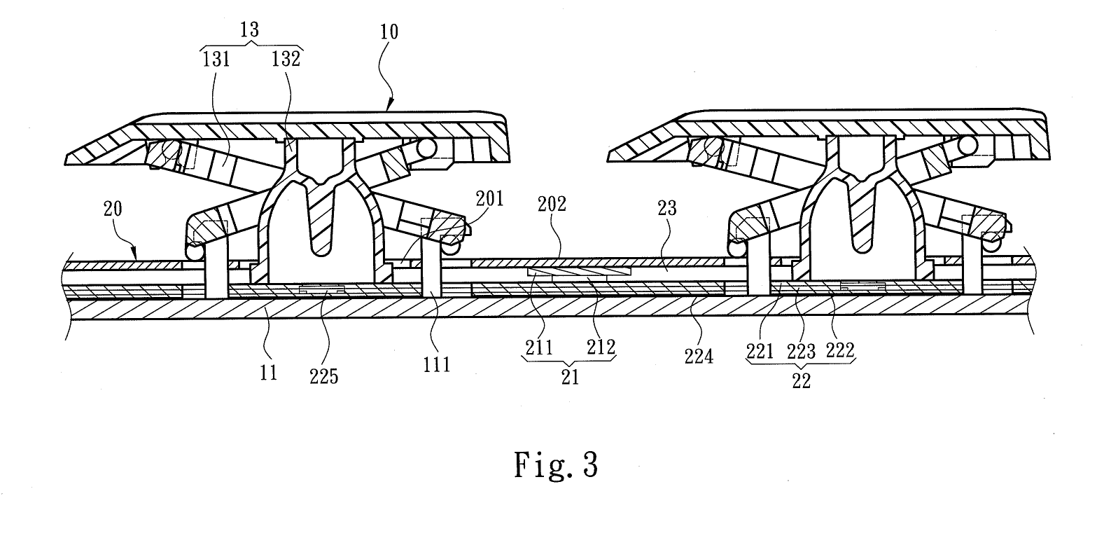

FIGS. 1 and 2 are exploded views of the structure of a first embodiment of the present invention. The illuminated keyboard with the light transmission channel of the present invention comprises a plurality of press units 10, a light shielding unit 20, at least one illuminating unit 21, a circuit board 22, a substrate 11, and a base plate 12. The plurality of press units 10, the substrate 11, and the base plate 12 disposed under the substrate 11 are defined as a key portion. The substrate 11 is used to hold the plurality of press units 10. A movement member 13 is disposed between each press unit 10 and the substrate 11. The movement member 13 includes a linkage mechanism 131 and a resilient element 132. Referring further to FIG. 3, the linkage mechanism 131 connects with at least one positioning portion 111 of the substrate 11 and each press unit 10. The resilient element 132 is disposed in the linkage mechanism 131 so that each press unit 10 can move towards the substrate 11.

The light shielding unit 20, the at least one illuminating unit 21, and the circuit board 22 are defined as a light guiding mechanism. The circuit board 22 is disposed on the substrate 11 to generate command signals when the press units 10 move towards the substrate 11. Preferably, the circuit board 22 includes three layers, but it is not the limitation. The circuit board 22 includes an upper film 221, a lower film 222, and an intermediate film 223 disposed between the upper film 221 and the lower film 222. The upper film 221 has an upper key circuit, and the lower film 222 has a lower key circuit; the intermediate film 223 has a plurality of through-holes 225 to allow the upper key circuit and the lower key circuit to form conduction (as illustrated in FIGS. 3 and 5-7). The light shielding unit 20 is disposed on the circuit board 22 and includes a light permeable area 201 and a light impermeable area 202. As shown in FIG. 3, the light permeable area 201 includes a plurality of apertures to allow multiple resilient elements 132 to trigger the circuit board 22 when moving towards the substrate 11.

Referring back to FIG. 1, the illuminating unit 21 is disposed between the circuit board 22 and the light shielding unit 20. A plurality of press units 10 arranged in each row are defined as a press unit assembly 100, and the illuminating unit 21 is disposed between any two or any three neighboring press unit assemblies 100. Preferably, the illuminating unit 21 can include an elongated light guide bar 211 and a plurality of luminous elements 212 embedded in the light guide bar 211. The number of the illuminating unit 21 and the luminous elements 212 can be increased or decreased according to various brightness requirements. It is preferable that the luminous element 212 is a light emitting diode.

FIG. 3 is a sectional view of the structure of the first embodiment of the present invention. The light permeable area 201 of the light shielding unit 20 corresponds to the plurality of press units 10, and the light impermeable area 202 corresponds to an area adjacent to the plurality of press units 10. The circuit board 22 includes a non-transparent surface 224. Preferably, the linkage mechanism 131 and the resilient element 132 are made of transparent material.

Since the light impermeable area 202 and the non-transparent surface 224 can block the light from penetrating, they form a light transmission channel 23 between the substrate 11 and the plurality of press units 10 to condense the light, thus improving the imperfection of conventional keyboards that a part of the light is dispersed in the keyboard when penetrating a thin-film circuit board. Furthermore, the light of the present invention is transmitted in the light transmission channel 23, so a light guiding portion can be omitted to decrease production processes and cost.

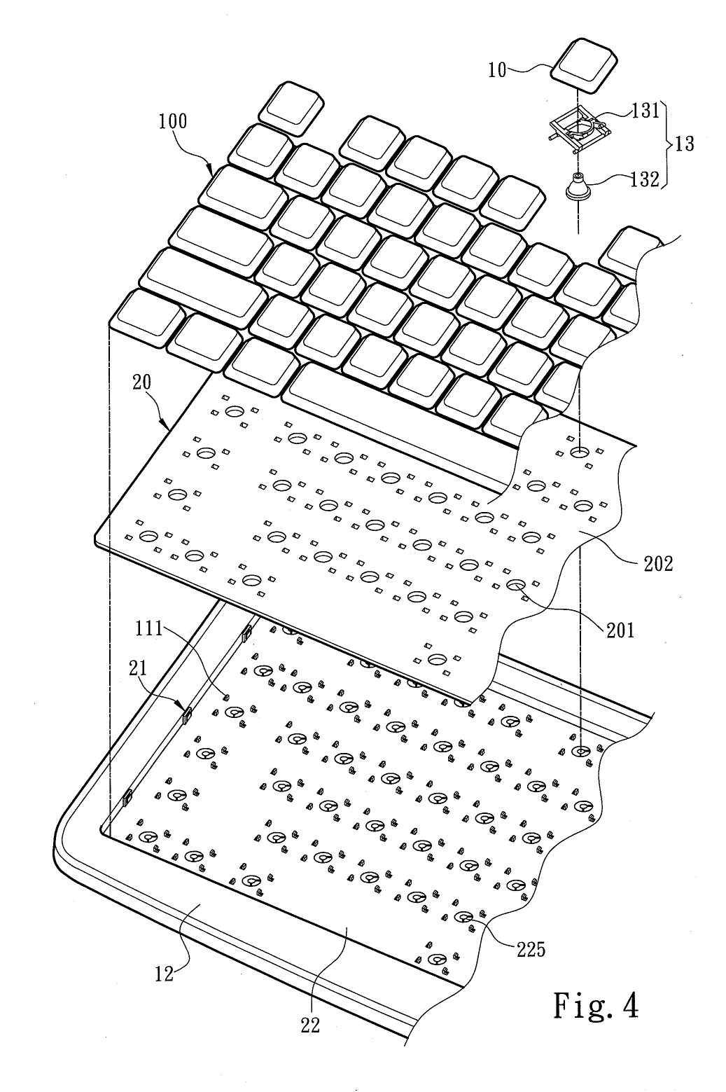

FIG. 4 is an exploded view of the structure of a second embodiment of the present invention. This embodiment differs from the first embodiment in that the illuminating unit 21 is not provided with the elongated light guide bar 211 disposed between two neighboring press unit assemblies 100. On the contrary, the illuminating unit 21 in the second embodiment is disposed on the base plate 12 to project light into the light transmission channel 23 as illustrated in FIG. 3. It is preferable that the illuminating unit 21 is a light emitting diode. Thereby, the illuminated keyboard of the present invention creates a light transmission channel 23 to condense light only by the light shielding unit 20 and the circuit board 22, thus greatly simplifying the light guiding mechanism to achieve the light-weight and thin-thickness features.

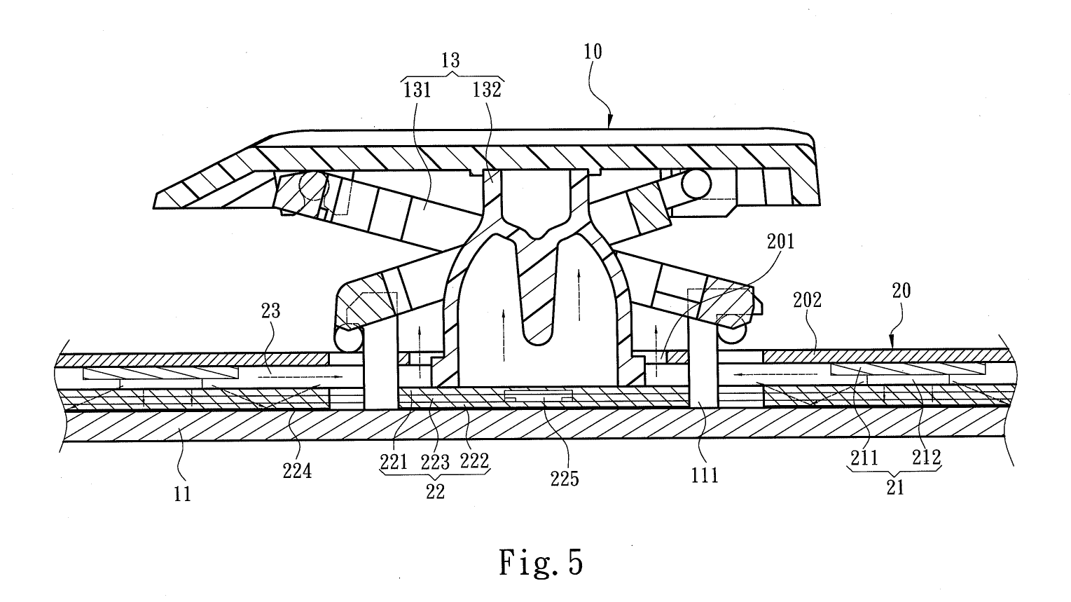

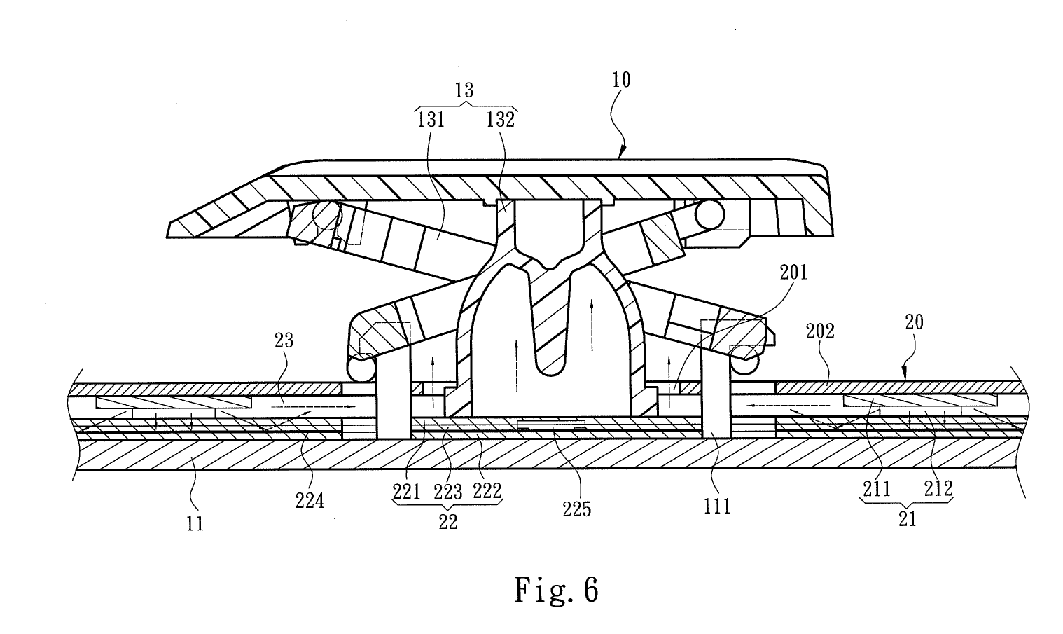

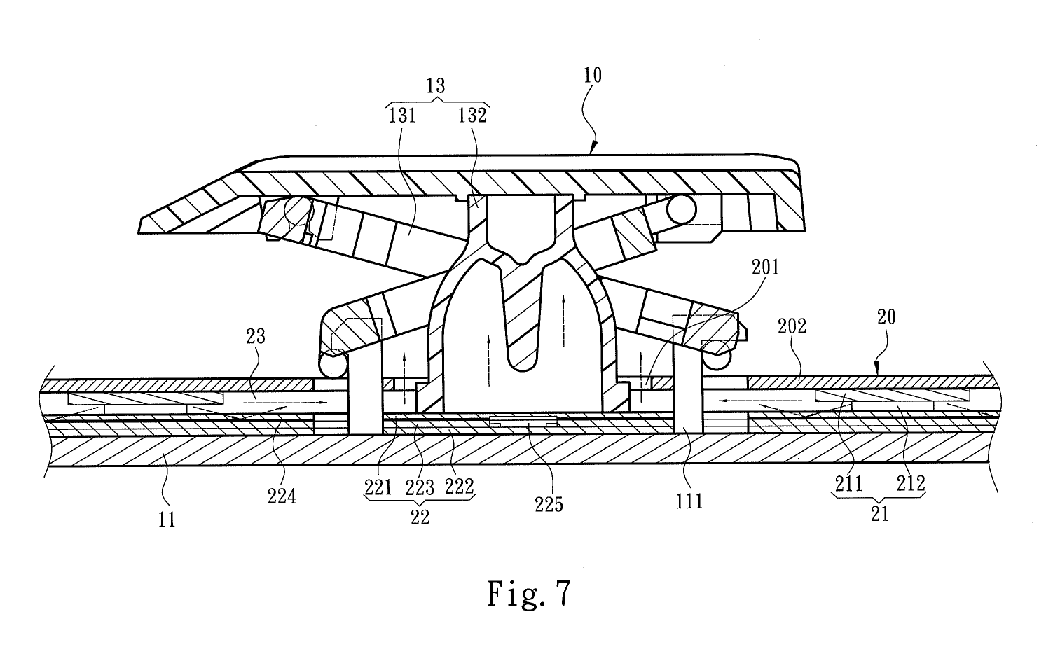

FIGS. 5-7 are schematic views showing the transmission of light in the first embodiment of the present invention. The differences among FIGS. 5-7 are the positions where the non-transparent surface 224 is located. As illustrated in FIG. 5, the non-transparent surface 224 is a reflective layer or an opaque layer located on the lower film 222. As illustrated in FIG. 6, the non-transparent surface 224 is a reflective layer or an opaque layer located on the intermediate film 223. As shown in FIG. 7, the non-transparent surface 224 is a reflective layer or an opaque layer located on the upper film 221. Therefore, according to the above-mentioned figures, the non-transparent surface 224 located on the upper film 221 forms the smallest cross section of the light transmission channel 23. With the non-transparent surface 224 located on the intermediate film 223 or the lower film 222, a part of light penetrates through the upper film 221 or the upper and the intermediate films 221, 223.

The non-transparent surface 224 may be disposed onto the lower film 222 via coating, attaching, or any other physical or chemical methods. For instance, the reflective layer may be a silver paint coated on the lower film 222, while the opaque layer can be a white paint coated on the lower film 222. In addition, the upper film 221, the lower film 222, and the intermediate film 223 may be directly made of opaque material or reflective material to eliminate the manufacture process for disposing the non-transparent surface 224 on the lower film 222. The opaque material and the reflective material are widely used on the market, therefore details are omitted herein.

In terms of the light transmission path, the light projected into the light transmission channel 23 from the illuminating unit 21 is constantly reflected in the light transmission channel 23 between the non-transparent surface 224 and the light impermeable area 202, or is transversely transmitted in the light transmission channel 23. No matter which direction the light is transmitted in the light transmission channel 23, the light eventually reaches the only exit of the light transmission channel 23, namely the light permeable area 201 of the light shielding unit 20. When the light passes through the light permeable area 201, a part of the light directly projects into the press unit 10, while the other part of the light is absorbed by the resilient element 132 and the linkage mechanism 131 to indirectly transmit to the press unit 10. Thereafter, the press unit 10 receives almost all the light projected from the illuminating unit 21. The press unit 10 of the illuminated keyboard has high brightness because it corresponds to the light permeable area 201, but the portion of the illuminated keyboard except the press unit 10 has no illumination because it corresponds to the light impermeable area 202. Thereby, the illuminated keyboard with a light transmission channel of the present invention has the feature of emitting the light unevenly.

In conclusion, the illuminated keyboard of the present invention forms a light transmission channel by means of the light impermeable area of the light shielding unit and the non-transparent surface of the circuit board so that light projected into the light transmission channel from the illuminating unit does not disperse in the illuminated keyboard when penetrating through the circuit board. Likewise, compared with the conventional techniques, the illuminated keyboard of the present invention is not needed to provide any light guiding portion, thus decreasing manufacture processes and production cost, and achieving slimness effect. Moreover, the illuminated keyboard of the present invention also can emit light unevenly by using the light permeable area and the light impermeable area of the light shielding unit so that a character or a symbol on each press unit can be clearly identified by a user.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illuminated keyboard with a light transmission channel, comprising:
a key portion including a plurality of press units and a substrate to hold the plurality of press units, each of the plurality of press units and the substrate being bridged by a movement member to allow the press unit to move towards the substrate;
a circuit board disposed on the substrate to generate command signals when the plurality of press units move towards the substrate, a light shielding unit which is disposed on the circuit board and includes a light permeable area and a light impermeable area, and at least one illuminating unit disposed between the circuit board and the light shielding unit, the light impermeable area of the light shielding unit and a non-transparent surface of the circuit board forming a light transmission channel between the substrate and the plurality of press units so that light generated by the at least one illuminating unit is transmitted in the light transmission channel and then projected into the plurality of press units via the light permeable area of the light shielding unit.

2. The illuminated keyboard with the light transmission channel of claim 1, wherein the circuit board includes an upper film, a lower film, and an intermediate film disposed between the upper film and the lower film.

3. The illuminated keyboard with the light transmission channel of claim 2, wherein the non-transparent surface is a reflective layer located on the lower film.

4. The illuminated keyboard with the light transmission channel of claim 2, wherein the non-transparent surface is an opaque layer located on the lower film.

5. The illuminated keyboard with the transmission channel of claim 2, wherein the non-transparent surface is a reflective layer located on the intermediate film.

6. The illuminated keyboard with the light transmission channel of claim 2, wherein the non-transparent surface is an opaque layer located on the intermediate film.

7. The illuminated keyboard with the light transmission channel of claim 2, wherein the non-transparent surface is a reflective layer located on the upper film.

8. The illuminated keyboard with the light transmission channel of claim 2, wherein the non-transparent surface is an opaque layer located on the upper film.

9. The illuminated keyboard with the light transmission channel of claim 2, wherein the lower film is made of an opaque material.

10. The illuminated keyboard with the light transmission channel of claim 2, wherein the lower film is made of a reflective material.

11. The illuminated keyboard with the light transmission channel of claim 2, wherein the intermediate film is made of an opaque material.

12. The illuminated keyboard with the light transmission channel of claim 2, wherein the intermediate film is made of a reflective material.

13. The illuminated keyboard with the light transmission channel of claim 2, wherein the upper film is made of an opaque material.

14. The illuminated keyboard with the light transmission channel of claim 2, wherein the upper film is made of a reflective material.

15. The illuminated keyboard with the light transmission channel of claim 2, wherein the upper film includes an upper key circuit, the lower film includes a lower key circuit, and the intermediate film includes a plurality of through-holes to allow the upper key circuit and the lower key circuit to form conduction.

16. The illuminated keyboard with the light transmission channel of claim 1, wherein the plurality of press units arranged in a row are defined as a press unit assembly, and the at least one illuminating unit is located in the light transmission channel between any two neighboring press unit assemblies.

17. The illuminated keyboard with the light transmission channel of claim 16, wherein the least one illuminating unit includes a light guide bar and a plurality of luminous elements embedded in the light guide bar.

18. The illuminated keyboard with the light transmission channel of claim 17, wherein each of the plurality of luminous elements is a light emitting diode.

19. The illuminated keyboard with the light transmission channel of claim 1, wherein the movement member includes a linkage mechanism connecting the substrate with each of the plurality of press units and a resilient element disposed in the linkage mechanism.

20. The illuminated keyboard with the light transmission channel of claim 19, wherein the light permeable area includes a plurality of apertures to allow multiple resilient elements to trigger the circuit board when moving towards the substrate.

21. The illuminated keyboard with the light transmission channel of claim 19, wherein the linkage mechanism is made of a transparent material.

22. The illuminated keyboard with the light transmission channel of claim 19, wherein the resilient element is made of a transparent material.

23. The illuminated keyboard with the light transmission channel of claim 19, wherein the substrate includes at least one positioning portion to secure the linkage mechanism thereon.

24. The illuminated keyboard with the light transmission channel of claim 1, wherein the light permeable area corresponds to the plurality of press units, and the light impermeable area corresponds to an area adjacent to the plurality of press units.

25. The illuminated keyboard with the light transmission channel of claim 1, wherein the at least one illuminating unit is a light emitting diode.

26. The illuminated keyboard with the light transmission channel of claim 1 further comprising a base plate disposed under the substrate.
